(19) United States
(12) Patent Application Publication
(10) Pub. No.: US 2011/0193913 A1
(43) Pub. Date: Aug. 11, 2011

(54) Inkjet head cleaning apparatus

(75) Inventors: Sung Nam Cho, Hwaseong (KR); Jun Young Kim, Suwon (KR); Jae Woo Joung, Suwon (KR)

(73) Assignee: SAMSUNG ELECTRO-MECHANICS CO., LTD., Suwon (KR)

(21) Appl. No.: 12/929,637

(22) Filed: Feb. 4, 2011

(30) Foreign Application Priority Data
Feb. 5, 2010 (KR) 10-2010-0011029

(51) Int. Cl. B41J 2/165

(52) U.S. Cl. 347/25

(57) ABSTRACT

There is provided an inkjet head cleaning apparatus including: an air blowing unit spaced apart from a nozzle ejecting ink at a predetermined distance and blowing air toward the nozzle; a blocking surface disposed to face the air blowing unit and blocking ink being removed from the nozzle due to the air released by the air blowing unit; a rebound blocking unit disposed between the blocking surface and the nozzle and blocking ink droplets being rebounded farther than a predetermined distance from the blocking surface among the ink blocked by the blocking surface; and a storage unit receiving the removed ink.

### CROSS-REFERENCE TO RELATED APPLICATIONS

This application claims the priority of Korean Patent Application No. 10-2010-0011029 filed on Feb. 5, 2010, in the Korean Intellectual Property Office, the disclosure of which is incorporated herein by reference.

### BACKGROUND OF THE INVENTION

1. Field of the Invention

The present invention relates to an inkjet head cleaning apparatus, and more particularly, to an inkjet head cleaning apparatus capable of effectively removing remaining ink from a nozzle surface of an inkjet head by blowing air thereonto.

2. Description of the Related Art

In recent years, an inkjet printer has widely been used in industrial fields. For example, it is used to directly form a circuit pattern by spraying ink prepared by melting metals such as gold or silver onto a printed circuit board (PCB), create industrial graphics, or manufacture a liquid crystal display (LCD), an organic light emitting diode (OLED), and the like.

In order for an inkjet printer to print a high-quality image, a nozzle of an inkjet head should be kept in an optimal state.

Specifically, when ink ejection is repeated through a nozzle of an inkjet head, ink remaining in or around the nozzle causes the contamination thereof. This may be a main factor in disturbing normal ink ejection. Accordingly, it is very important to clean the nozzle of the inkjet head in a maintenance process.

According to the related art, inkjet head cleaning has been performed by a contact method in which ink remaining on a nozzle surface is directly cleaned using a wiper, a non-woven cloth, or the like, or a non-contact method in which the remaining ink is subjected to vacuum suction.

However, the contact method may have problems such as a secondary contamination caused by direct contact or the damage of a water repellent layer around a nozzle caused by a polishing action. Also, the non-contact method including vacuum suction may have a problem that it is difficult to perfectly remove the remaining ink.

In order to solve these problems, a method of blowing air toward the ink remaining on a nozzle surface has been developed so that the remaining ink can be effectively removed without the direct contact of the nozzle surface.

However, such an air blowing method may have a problem that the ink removed by air blowing pressure is rebounded from the inner wall of a cleaning apparatus and re-contaminates the nozzle surface of an inkjet head.

### SUMMARY OF THE INVENTION

An aspect of the present invention provides an inkjet head cleaning apparatus capable of effectively removing remaining ink from a nozzle surface of an inkjet head using an air blowing method by preventing the ink from being rebounded against an inner wall of the cleaning apparatus and avoiding the re-contamination of the nozzle surface.

According to an aspect of the present invention, there is provided an inkjet head cleaning apparatus including: an air blowing unit spaced apart from a nozzle ejecting ink at a predetermined distance and blowing air toward the nozzle; a blocking surface disposed to face the air blowing unit and blocking ink being removed from the nozzle due to the air released by the air blowing unit; a rebound blocking unit disposed between the blocking surface and the nozzle and blocking ink droplets being rebounded farther than a predetermined distance from the blocking surface among the ink blocked by the blocking surface; and a storage unit receiving the removed ink.

The rebound blocking unit may be a screen spaced apart from the blocking surface toward the air blowing unit at a predetermined distance.

The screen may have a water-repellent coating layer on a surface thereof.

The rebound blocking unit may be an ink absorption layer disposed on the blocking surface and absorbing the removed ink.

The air blowing unit may be an air blade blowing compressed air.

The inkjet head cleaning apparatus may further include a heating unit disposed adjacent to the blocking surface and supplying heat so as to reduce viscosity of the ink smeared on the blocking surface.

The inkjet head cleaning apparatus may further include an inclined surface being inclined at a predetermined angle under the nozzle so that the ink dropped from the nozzle is collected in one direction.

The inclined surface may have a water-repellent coating layer thereon.

The inkjet head cleaning apparatus may further include a heating unit disposed adjacent to the inclined surface and supplying heat so as to reduce viscosity of the ink smeared on the inclined surface.

The blocking surface may have a water-repellent coating layer thereon.

The inkjet head cleaning apparatus may further include a vacuum pump connected to the storage unit and assisting in collecting the ink being removed from the nozzle into the storage unit.

The air blowing unit may blow air to a bottom surface of the nozzle at an angle of 0 to 30 degrees.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic view illustrating the configuration of an inkjet head cleaning apparatus according to an exemplary embodiment of the present invention;

FIGS. 2A and 2B are views illustrating sequential processes of removing ink from a nozzle using an inkjet head cleaning apparatus according to an exemplary embodiment of the present invention; and

FIG. 3 is a view illustrating an angle between a nozzle surface and an air blowing unit in an inkjet head cleaning apparatus according to another exemplary embodiment of the present invention.

### DETAILED DESCRIPTION OF THE PREFERRED EMBODIMENT

Exemplary embodiments of the present invention will now be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art. Moreover, detailed descriptions related to well-known functions or configurations will be ruled out in order not to unnecessarily obscure the subject matter of the present invention.

Throughout the drawings, the same reference numerals will be used to designate the same or like elements.

In addition, when one element is referred to as being “connected” to another element, it should be understood that the former can be “directly connected” to the latter, or “indirectly connected” to the latter via an intervening element. Furthermore, unless explicitly described to the contrary, the word “include” and variations such as “includes” or “including,” will be understood to imply the inclusion of stated elements but not the exclusion of any other elements.

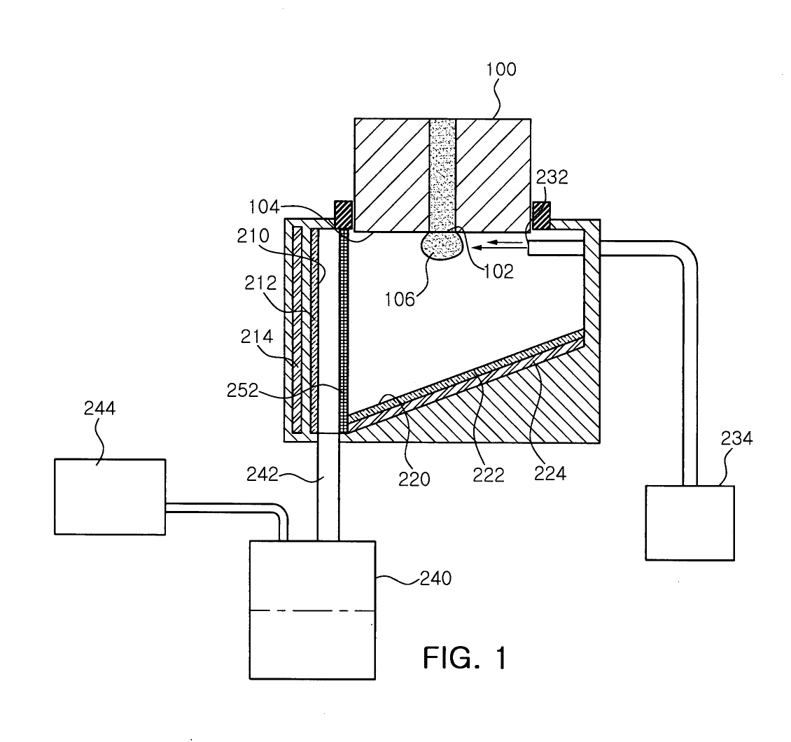

FIG. 1 is a schematic view illustrating the configuration of an inkjet head cleaning apparatus according to an exemplary embodiment of the present invention.

With reference to FIG. 1, an inkjet head cleaning apparatus may include an air blowing unit 232, an air pressure generating unit 234, a blocking surface 210, an inclined surface 220, a storage unit 240 and a rebound blocking unit.

The air blowing unit 232 is spaced apart from a nozzle 102 of an inkjet head 100 at a predetermined distance such that it may blow air toward remaining ink 106 in order to remove the remaining ink 106 from the nozzle 102.

Here, the air blowing unit 232 may be an air blade blowing compressed air.

Also, the air blowing unit 232 may be connected to the air pressure generating unit 234 generating air pressure and supplying the generated air pressure to the air blowing unit 232.

The blocking surface 210 may be disposed to face the air blowing unit 232 with relation to the air blowing direction thereof. The blocking surface 210 may block the remaining ink removed due to the air pressure from the air blowing unit 232.

Here, the blocking surface 210 has a water-repellent coating layer 212 thereon so that the remaining ink being removed may flow smoothly on the blocking surface 210 without wetting.

Also, a heating unit 214 is provided adjacent to the blocking surface 210 and reduces the viscosity of the ink smeared on the blocking surface 210 so that ink flow may be improved.

The rebound blocking unit may be disposed between the blocking surface 210 and the nozzle 102. The rebound blocking unit may block ink droplets being rebounded farther than a predetermined distance from the blocking surface 210 among the ink blocked by the blocking surface 210. The rebound blocking unit may be realized as a screen 252 or as an ink absorption layer.

The screen 252 may be spaced apart from the blocking surface 210 toward the air blowing unit 232 at a predetermined distance. The screen 252 may prevent the ink, removed from the nozzle 102 due to the air pressure from the air blowing unit 232, from being rebounded from the blocking surface 210, thereby avoiding the re-contamination of the nozzle 102. Here, the surface of the screen 252 is subjected to a water-repellent coating process so that the ink smeared on the screen 252 may flow smoothly downwardly.

Meanwhile, the ink absorption layer, instead of the screen 252, may be provided on the blocking surface 210 so that it serves to absorb ink in order to prevent the ink from being rebounded from the blocking surface 210.

The inclined surface 220 is inclined at a predetermined angle under the nozzle 102 so that the ink dropped from the nozzle 102 may gather in one direction to be efficiently collected in the storage unit 240.

Here, the inclined surface 220 has a water-repellent coating layer 222 thereon so that the remaining ink being removed may flow smoothly on the inclined surface 220 without wetting.

Also, a heating unit 224 is provided adjacent to the inclined surface 220 and reduces the viscosity of the ink smeared on the inclined surface 220 so that ink flow may be improved.

The storage unit 240 may be provided to receive the remaining ink removed from the nozzle 102. Here, a vacuum pump 244 may be connected to the storage unit 240 so as to assist in collecting the ink being removed from the nozzle 102 into the storage unit 240.

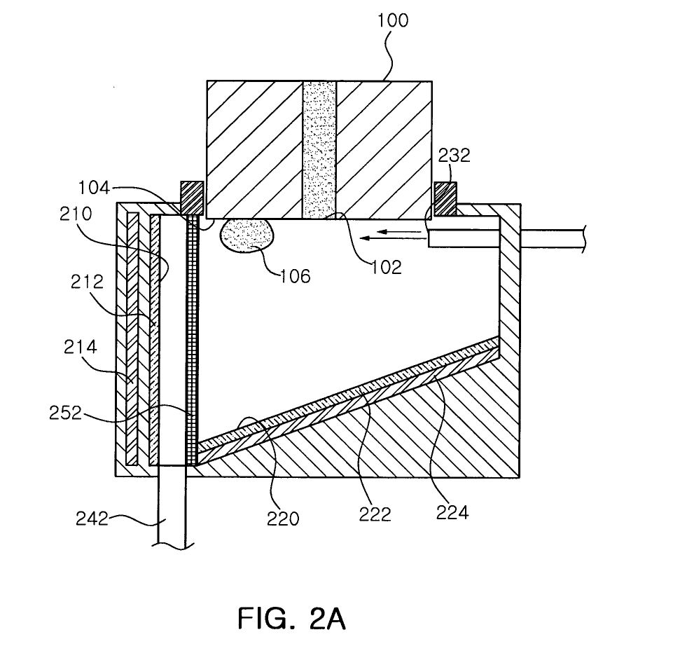

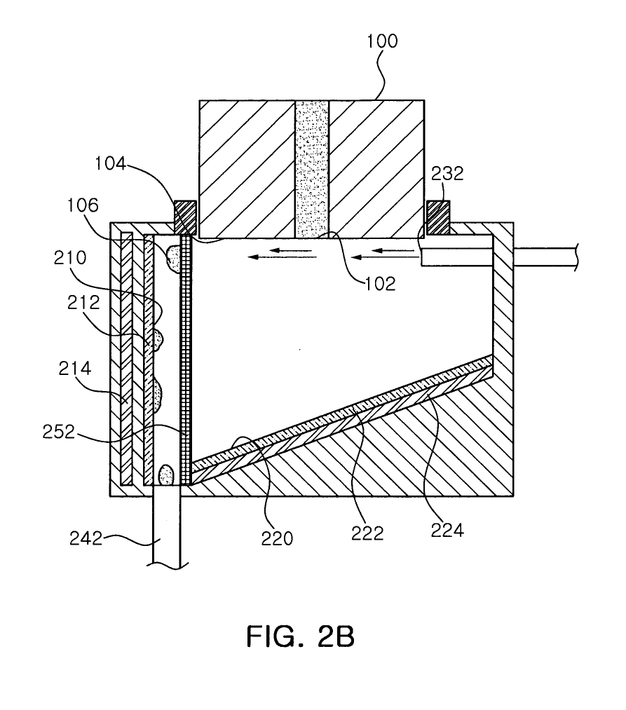

FIGS. 2A and 2B are views illustrating sequential processes of removing ink from a nozzle using an inkjet head cleaning apparatus according to an exemplary embodiment of the present invention.

With reference to FIGS. 2A and 2B, the remaining ink 106 around the nozzle 102 is moved along a nozzle surface 104 due to the air pressure from the air blowing unit 232. The ink being removed from the nozzle 102 strikes the blocking surface 210. At this time, part of the remaining ink 106 may fail to reach the blocking surface 210, and thus drop to the inclined surface 220.

The ink striking the blocking surface 210 may flow along the blocking surface 210 downwardly or be rebounded to the nozzle 102. In the case that the rebounded ink reaches the nozzle 102, the nozzle 102 may be re-contaminated. In order to solve this problem, the screen 252 may prevent the ink being rebounded from the blocking surface 210 from reaching the nozzle 102 to thereby avoid secondary contamination.

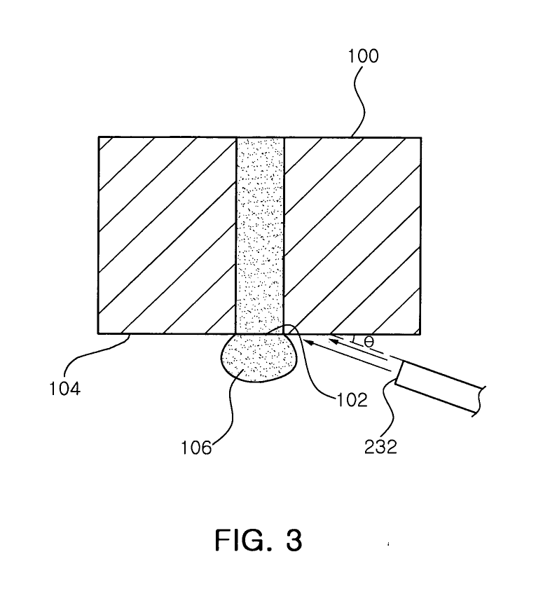

FIG. 3 is a view illustrating an angle between a nozzle surface and an air blowing unit in an inkjet head cleaning apparatus according to another exemplary embodiment of the present invention.

The air blowing unit 232 may be parallel to the nozzle surface 104 of an inkjet head or be disposed to have a predetermined angle relative to the nozzle surface 104.

Meanwhile, the ink is required to have a meniscus shape on the surface of the nozzle 102 for stable ink ejection. However, in the case that the angle θ of the air blowing unit 232 relative to the nozzle surface 104 is too large, this breaks the meniscus shape and causes difficulty in stable ink ejection. Therefore, the angle θ of the air blowing unit 232 relative to the nozzle surface 104 may range approximately from 0 to 30 degrees.

As set forth above, according to exemplary embodiments of the invention, an inkjet head cleaning apparatus includes a rebound blocking unit between a blocking surface and an air blowing unit so that it may prevent remaining ink from being rebounded to a nozzle to thereby avoid the re-contamination of the nozzle.

While the present invention has been shown and described in connection with the exemplary embodiments, it will be apparent to those skilled in the art that modifications and variations can be made without departing from the spirit and scope of the invention as defined by the appended claims.

What is claimed is:

1. An inkjet head cleaning apparatus comprising:
an air blowing unit spaced apart from a nozzle ejecting ink at a predetermined distance and blowing air toward the nozzle;
a blocking surface disposed to face the air blowing unit and blocking ink being removed from the nozzle due to the air released by the air blowing unit;
a rebound blocking unit disposed between the blocking surface and the nozzle and blocking ink droplets being rebounded farther than a predetermined distance from the blocking surface among the ink blocked by the blocking surface; and
a storage unit receiving the removed ink.

2. The inkjet head cleaning apparatus of claim 1, wherein the rebound blocking unit is a screen spaced apart from the blocking surface toward the air blowing unit at a predetermined distance.

3. The inkjet head cleaning apparatus of claim 2, wherein the screen has a water-repellent coating layer on a surface thereof.

4. The inkjet head cleaning apparatus of claim 1, wherein the rebound blocking unit is an ink absorption layer disposed on the blocking surface and absorbing the removed ink.

5. The inkjet head cleaning apparatus of claim 1, wherein the air blowing unit is an air blade blowing compressed air.

6. The inkjet head cleaning apparatus of claim 1, further comprising a heating unit disposed adjacent to the blocking surface and supplying heat so as to reduce viscosity of the ink smeared on the blocking surface.

7. The inkjet head cleaning apparatus of claim 1, further comprising an inclined surface being inclined at a predetermined angle under the nozzle so that the ink dropped from the nozzle is collected in one direction.

8. The inkjet head cleaning apparatus of claim 7, wherein the inclined surface has a water-repellent coating layer thereon.

9. The inkjet head cleaning apparatus of claim 7, further comprising a heating unit disposed adjacent to the inclined surface and supplying heat so as to reduce viscosity of the ink smeared on the inclined surface.

10. The inkjet head cleaning apparatus of claim 1, wherein the blocking surface has a water-repellent coating layer thereon.

11. The inkjet head cleaning apparatus of claim 1, further comprising a vacuum pump connected to the storage unit and assisting in collecting the ink being removed from the nozzle into the storage unit.

12. The inkjet head cleaning apparatus of claim 1, wherein the air blowing unit blows air to a bottom surface of the nozzle at an angle of 0 to 30 degrees.
